(19) United States
(12) Patent Application Publication
(10) Pub. No.: US 2014/0344714 A1
(43) Pub. Date: Nov. 20, 2014

(54) DISPLAY DEVICE, INFORMATION TERMINAL DEVICE, DISPLAY METHOD, AND RECORDING MEDIUM

(71) Applicant: SHARP KABUSHIKI KAISHA, Osaka-shi, Osaka (JP)

(72) Inventors: Hiroki Toyoshima, Osaka-shi (JP); Akihiro Azuma, Osaka-shi (JP); Hiroki Kagawa, Osaka-shi (JP); Takayoshi Sasaoka, Osaka-shi (JP); Michita Katayama, Osaka-shi (JP)

(21) Appl. No.: 14/363,134

(22) PCT Filed: Nov. 28, 2012
(86) PCT No.: PCT/JP2012/080742

§ 371 Date: Jun. 5, 2014

(30) Foreign Application Priority Data
Dec. 8, 2011 (JP) 2011-269392

(51) Int. Cl. G06F 3/0484; H04L 12/58; G06F 3/0485; G06F 3/01

(52) U.S. Cl. CPC G06F 3/04842; G06F 3/017; H04L 51/04; G06F 3/0485
USPC 715/752

(57) ABSTRACT

An information terminal device (100) includes a message display section (304) which (i) displays a plurality of display regions on a display screen so that the plurality of display regions are arranged along a vertical direction of the display screen, the plurality of display regions each being for a time series, and (ii) displays, in each of the plurality of display regions, a posted message of a time series corresponding to the each of the plurality of display regions; and display change section (308) which, in a case where a horizontal moving operation is carried out with respect to a given one of the plurality of display regions, sequentially changes a posted message to be displayed in the given one of the plurality of display regions.

### TECHNICAL FIELD

The present invention relates to a display device and an information terminal device which are capable of displaying, on a display screen, a posted message of a message-posting site. The present invention also relates to a display method, a program, and a recording medium which are used in the display device and the information terminal device.

### BACKGROUND ART

In recent years, the use of SNS (Social Network Service) is rapidly growing. In particular, many users use what are called message-posting sites, which are communication services enabling users of a network to communicate with each other.

A message-posting site works in such a manner that each user posts a message from a terminal device at given timing, and messages posted (hereinafter referred to as “posted messages”) by each user are displayed one after the other on a real-time basis on each terminal device. The act of posting a message to a message-posting site is also called “twittering”.

Particularly these days, not only individuals but also companies, organizations, and the like have obtained their own accounts to utilize a message-posting site as an information-offering tool. Typical examples of such message-posting sites include “Twitter (Registered Trademark)” (see Non-patent Literature 1 below). “Twitter” in particular can be classified as what is called a “microblogging site” because “Twitter” limits the number of letters of a posted message relatively small.

In general, each posted message posted on a message-posting site is associated with a posting date and time of the each posted message. Accordingly, a plurality of messages posted on the message-posting site constitute a time series of the plurality of posted messages. On a terminal device which has obtained the time series from the message-posting site, the plurality of posted messages included in the time series are displayed so as to be arranged along a vertical direction of a display screen in order of posting (such a time series is called “timeline” in “Twitter”). Every time a new message is posted on the message-posting site, the time series is updated and the update is immediately reflected to the terminal device (that is, displayed on a real-time basis).

At this time, in a case where not all of the posted messages can fit in the display screen, a part of the posted messages (for example, some posted messages starting from the most recently posted message) is displayed. A user of the terminal device can view the rest of the posted messages by scrolling the time series in the vertical direction, thereby causing the rest of the posted messages to be displayed sequentially on the display screen.

Particularly these days, the use of information terminal devices, such as an electronic book reader, a smart phone, and the like, which include a touch panel is increasingly spreading. With such an information terminal device, by carrying out a vertical flicking operation on a display screen displaying a time series of a plurality of posted messages, the plurality of posted messages constituting the time series can be scrolled in a vertical direction of the display screen so as to be sequentially displayed.

### CITATION LIST

### Patent Literature

[Patent Literature 1]
Japanese Patent Application Publication, Tokukai, No. 2006-145908 A (Publication Date: Jul. 17, 2008)

### Non-patent Literature

[Non-patent Literature 1]
Twitter, Inc., “Twitter”, [online], Twitter, Inc., [Search date: Nov. 30, 2011], the Internet <URL: http://twitter.com/>

### SUMMARY OF INVENTION

### Technical Problem

In “Twitter”, by specifying a specific account (a user account, a plurality of user accounts, a group account including a plurality of user accounts, or the like (hereinafter collectively referred to as “specific account”)), a time series that includes only posted messages of the specific account can be displayed. It is also possible in “Twitter” to specify a plurality of specific accounts to thereby cause a time series of each of the plurality of specific accounts to be displayed.

However, it is not possible in “Twitter” to display a plurality of time series simultaneously. As such, in order to view a plurality of time series, a user needs to carry out a relatively time-consuming operation, for example, displaying a list of time series and selecting a given time series, to thereby change the time series to be displayed on the display screen.

Conventionally, there has been use of a technique in which a plurality of pieces of content are displayed side by side on a display screen and, even in a case where not all of the plurality of pieces of content fit in the display screen, all of the plurality of pieces of content can be viewed by scrolling the display screen (for example, see Patent Literature 1 above).

In this technique, however, in a case where content that requires a scrolling operation (e.g., a time series of posted messages) is included in the plurality of pieces of content, a scrolling operation of the content and a scrolling operation of the display screen need to be carried out in a distinguishable manner. This complicates each of these scrolling operations. Further, in a case where the user fails to carry out each scrolling operation properly, an operation not intended by the user will be carried out. For example, an operation intended for a scrolling operation of content may cause a scrolling operation of the display screen to be carried out, and vice versa.

The present invention is accomplished in view of the above problem. An object of the present invention is to provide a display device which allows a plurality of time series of posted messages of a message-posting site to be viewed by a simple and reliable operation.

### Solution to Problem

In order to achieve the object, a display device in accordance with the present invention is a display device capable of displaying, on a display screen, a posted message of a message-posting site, including: message display means which (i) displays a plurality of display regions on the display screen so that the plurality of display regions are arranged along a first direction of the display screen, the plurality of display regions each being for a time series of posted messages, and (ii) displays, in each of the plurality of display regions, a posted message of a time series corresponding to the each of the plurality of display regions; and display change means which, in a case where a moving operation in a second direction, which is different from the first direction, is carried out with respect to a given one of the plurality of display regions, sequentially changes a posted message to be displayed in the given one of the plurality of display regions.

### Advantageous Effects of Invention

The display device, the display device, the information terminal device, the display method, the program, and the recording medium in accordance with the present invention make it possible to provide a display device that allows viewing a plurality of time series of posted messages of a message-posting site by means of a simple and reliable operation.

### BRIEF DESCRIPTION OF DRAWINGS

FIG. 1 is a view illustrating an outer appearance of an information terminal device in accordance with an embodiment.

FIG. 2 is a block diagram illustrating a configuration of an information terminal device in accordance with an embodiment.

FIG. 3 is a block diagram illustrating a configuration of a display control function of an information terminal device in accordance with an embodiment.

FIG. 4 is a flowchart showing procedures of a display process carried out by an information terminal device in accordance with an embodiment.

FIG. 5 is a view illustrating a specific example of a display process carried out by an information terminal device in accordance with an embodiment, the view illustrating an example of how a message display section causes a plurality of display regions to be displayed.

FIG. 6 is a view illustrating a specific example of a display process carried out by an information terminal device in accordance with an embodiment, the view illustrating an example of a horizontal flicking operation.

FIG. 7 is a view illustrating a specific example of a display process carried out by an information terminal device in accordance with an embodiment, the view illustrating an example of how a display change section causes content displayed on a display screen to be changed.

FIG. 8 is a view illustrating a specific example of a display process carried out by an information terminal device in accordance with an embodiment, the view illustrating an example of a vertical flicking operation.

FIG. 9 is a view illustrating a specific example of a display process carried out by an information terminal device in accordance with an embodiment, the view illustrating an example of how a display change section causes content displayed on a display screen to be changed.

FIG. 10 is a view illustrating a specific example of a display process carried out by an information terminal device in accordance with an embodiment, the view illustrating an example of how a display change section causes content displayed on a display screen to be changed.

FIG. 11 is a view illustrating a specific example of a display process carried out by an information terminal device in accordance with an embodiment, the view illustrating an example of a horizontal flicking operation.

### DESCRIPTION OF EMBODIMENTS

The following description will discuss an embodiment of the present invention with reference to drawings.

### Embodiment

(General description of information terminal device 100)

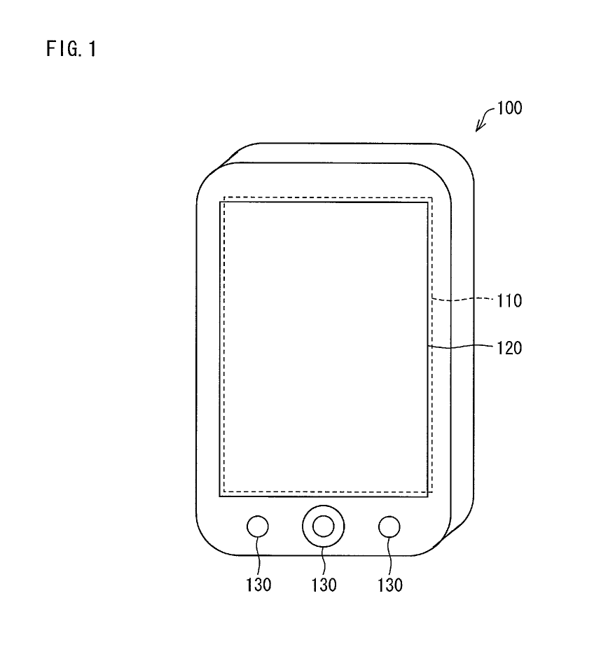

First, the following will deal with an embodiment in accordance with the present invention. With reference to FIG. 1, the description will first give a general description of an information terminal device 100 in accordance with the embodiment. FIG. 1 is a view illustrating an outer appearance of the information terminal device 100 in accordance with the embodiment.

The information terminal device 100 illustrated in FIG. 1 is an information terminal device having portability and transportability and capable of using various services and various applications. Specifically, the information terminal device 100 is relatively small sized and has a battery such as a lithium ion secondary battery incorporated therein. This allows the information terminal device 100 to be carried around easily and used in places away from home by being battery driven without an external power supply (AC power supply).

The information terminal device 100 includes a display 110 which displays various information. The information terminal device 100 also includes a touch panel 120 and an operation button 130, which are provided for various operations. The touch panel 120 is disposed over a surface of the display 110.

This allows the information terminal device 100 to have general consistency between a position on the display 110 where an object to be displayed is displayed and a position on the touch panel 120 where an operation with respect to the object to be displayed is carried out. Accordingly, the user can carry out an intuitive operation (selecting operation, moving operation, etc.) with respect to the object to be displayed.

Operations that can be carried out via the touch panel 120 include an operation known as “flicking operation”. The flicking operation is an operation of sliding the tip of a finger in touching the touch panel 120 so that the position of contact between the tip of the finger and the touch panel 120 is moved in a given direction. When a flicking operation is carried out, the information terminal device 100 can, for example, scroll the position where the object to be displayed is displayed or change the content to be displayed, in accordance with a position of contact, a direction of movement, a speed of movement, and the like of the flicking operation.

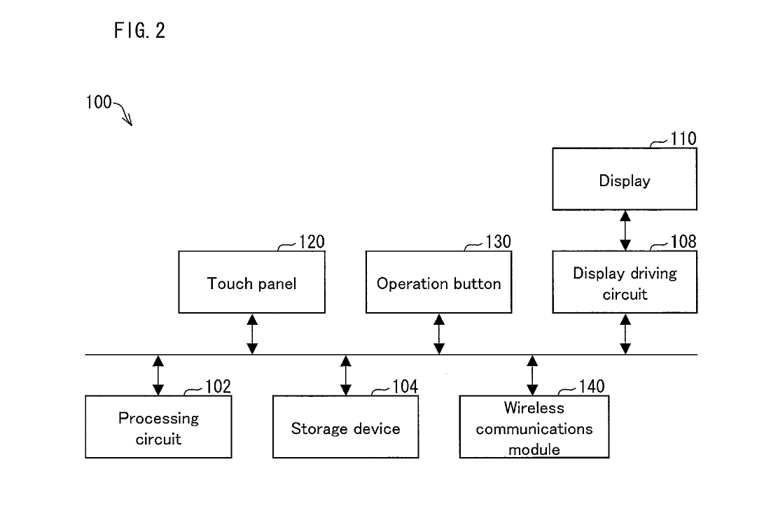

The information terminal device 100 further includes a wireless communications module 140 (see FIG. 2). This allows the information terminal device 100 to access the Internet and use various services available on the Internet.

The information terminal device 100 has various applications installed therein. For example, the information terminal device 100 has installed therein an application for viewing electronic data. This allows the information terminal device 100 to display book data on the display 110, so that the user can view the book data. When viewing the book data, the user can carry out various operations such as turning over pages via the touch panel 120 or the operation button 130.

The information terminal device 100 has also installed therein an application for purchasing electronic data from an electronic book site on the Internet. This allows the user to purchase desired book data from the electronic data site via the information terminal device 100 and download the purchased book data via the information terminal device 100.

The information terminal device 100 has also installed therein an application for using a message-posting site on the Internet. This allows the user to post a message to the message-posting site via the information terminal device 100 and view a posted message on the message-posting site via the information terminal device 100.

Note that methods for using electronic data and a message-posting site via the information terminal device 100 are not limited to the above-described ones which use dedicated applications. For example, the user can access a specific website on the Internet and, via a web page accordingly displayed on a WEB browser, use electronic data and a message-posting site.

(Configuration of Information Terminal Device 100)

Next, with reference to FIG. 2, the following description will discuss a configuration of the information terminal device 100 in accordance with the embodiment. FIG. 2 is a block diagram illustrating a configuration of the information terminal device 100 in accordance with the embodiment.

As illustrated in FIG. 2, the information terminal device 100 includes a processing circuit 102, a storage device 104, the touch panel 120, the operation button 130, a display driving circuit 108, the display 110, and the wireless communications module 140.

(Storage Device 104)

The storage device 104 stores therein an OS (Operating System) program, various application programs, various control programs, various data, and the like. For example, the storage device 104 stores therein an application program for viewing electronic data, an application program for purchasing electronic data, an application program for using a message-posting site, and the like. The storage device 104 also stores therein book data purchased from an electronic data site, and the like.

Examples of the storage device 104 in the embodiment are not limited to those built in the information terminal device 100, such as an HDD (Hard disk drive), an SSD (Solid State Drive), and the like, and include those which are detachable, such a memory card.

(Processing Circuit 102)

The processing circuit 102 includes a processor such as a CPU and a memory such as a ROM (Read Only Memory) or a RAM (Random Access Memory). The processor executes a program stored in the memory or the storage device 104, so that various applications are executed and each section of the information terminal device 100 is controlled.

(Touch Panel 120 and Operation Button 130)

The touch panel 120 and the operation button 130 each serve as an input device via which the user carries out various operations with respect to the information terminal device 100. The touch panel 120 is disposed over a surface of a display panel included in the display 110. The operation button 130 is provided on a surface of a body of the information terminal device 100. Apart from these, a key, a mouse, and the like may be employed as the input device.

(Display Driving Circuit 108 and Display 110)

The display driving circuit 108 drives the display 110 in accordance with a video signal supplied from the processing circuit 102. The display 110 displays a video in accordance with a result of execution of a program carried out by the processing circuit 102. In this way, the display 110 functions as display means for displaying book data, a posted message, and the like. The information terminal device 100 of the present embodiment employs a liquid crystal display as the display 110, but may employ other displays such as an organic EL display.

(The Wireless Communications Module 140)

The wireless communications module 140 controls a wireless access to a communications network such as a LAN or the Internet. For example, the information terminal device 100 can communicate data with a server or other terminal devices on the Internet by connecting to the Internet via wireless communication. At this time, the access to the Internet is controlled by the wireless communications module 140.

(Display Function)

The following description will specifically discuss a display function of the information terminal device 100 of the present embodiment. The display function in the present embodiment means a display function related to display of a posted message obtained from a message-posting site.

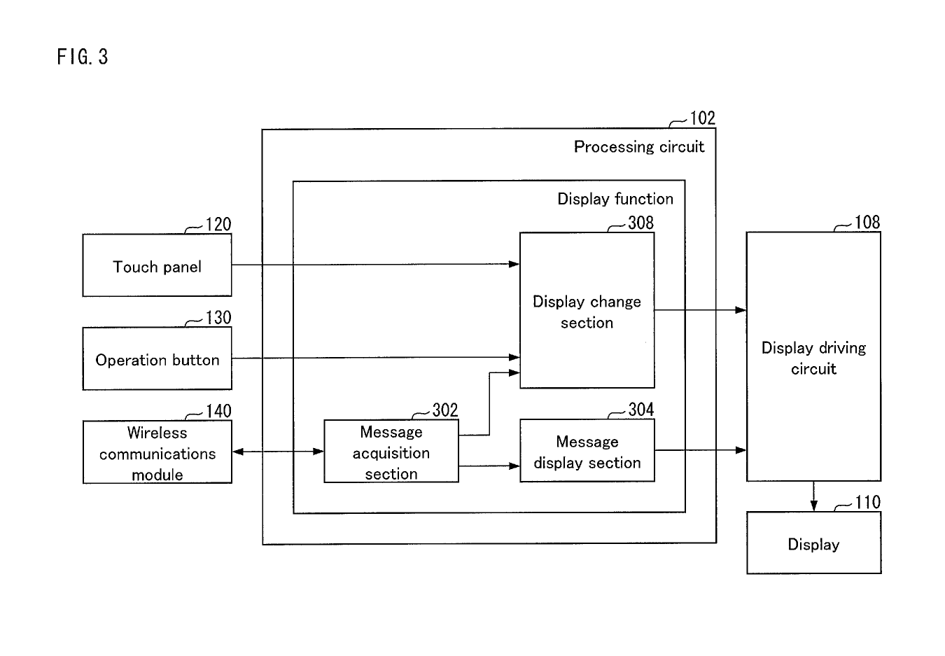

First, with reference to FIG. 3, the following will describe a configuration of the display function of the information terminal device 100. FIG. 3 is a block diagram illustrating a configuration of a display control function of the information terminal device 100 in accordance with the embodiment.

As illustrated in FIG. 3, the processing circuit 102 of the information terminal device 100 includes, as a display function related to display of a posted message, a message acquisition section 302, a message display section 304, and a display change section 308.

(Message Acquisition Section)

The message acquisition section 302 obtains a posted message from a posting site (specifically, a server device for the posting site) on the Internet via the wireless communications module 140.

The message acquisition section 302 can obtain, from the message-posting site, a time series of posted messages (hereinafter simply referred to as “time series”) constituted solely by posted messages of a specific account.

The message acquisition section 302 can also obtain, from the message-posting site, a time series of each of a plurality of specific accounts.

In this case, if the plurality of specific accounts belong to a plurality of posting sites, the message acquisition section 302 obtains, from each of the plurality of posting sites, a time series of a corresponding one of the specific accounts.

The user can set any account as a specific account via the information terminal device 100. For example, the user can set, as a specific account, an account of another user, a company, an organization, a service, or the like that the user has come to know through various Internet sites such as a posting site. This allows the message acquisition section 302 to obtain a time series of the another user, the company, the organization, the service, or the like. As a result, the user can view, easily on a real-time basis, information sent out from the other user, the company, the organization, the service, or the like which interests the user.

In another case, a specific account is automatically set by an application used by the information terminal device 100. For example, the information terminal device 100 can obtain an account of each of a plurality of services by using an information providing site or the like that distributes information related to the plurality of services. This allows the message acquisition section 302 to obtain a time series of each of the plurality of services. Consequently, the user can view, easily on a real-time basis, information sent out from each of the plurality of services.

(Message Display Section)

The message display section 304 causes a posted message obtained by the message acquisition section 302 to be displayed on the display 110. The displaying of the posted message can be realized by means a dedicated application installed in the information terminal device 100, or can be realized by means of a web page displayed on a web browser. The posted message is displayed by the message display section 304 by the following display method.

The message display section 304 causes time series of a respective plurality of specific accounts to be simultaneously displayed on the display screen of the display 110. Specifically, the message display section 304 causes a plurality of display regions for the respective time series (that is, one display region per account) to be displayed on the display screen of the display 110 so as to be arranged along a vertical direction. For example, in a case where three time series have been obtained by the message acquisition section 302, the three display regions are displayed so as to be arranged along the vertical direction.

Then, the message display section 304 causes posted messages of a time series corresponding to each of the plurality of display regions to be displayed one by one in the each of the plurality of display regions. Note that, by default, the most recently posted message is displayed one by one, but the present embodiment is not limited to this. In this way, posted messages of the plurality of time series are simultaneously displayed, one posted message per time series, on the display screen of the display 110.

The information terminal device 100 of the present embodiment thus causes time series of a respective plurality of accounts to be displayed simultaneously and also causes the most recently posted message of each of the plurality of accounts to be displayed. This allows the user to view easily the most recent information of each of the plurality of accounts.

Note that, in a case where not all of the display regions to be displayed fit in the display screen, the message display section 304 causes a part of the display regions to be displayed on the display screen.

Basically each display region has a fixed size, but the message display section 304 may change the size of each display region in accordance with the amount of information of a posted message displayed in the display region (specifically, a display area required for displaying the posted messages). For example, the message display section 304 may change the size of each display region in the vertical direction while keeping the size of the each display region in the horizontal direction fixed.

In a case where the size of each display region is fixed, the message display section 304 can cause a part of a posted message to be displayed in each display region, or can reduce the size of a posted message and cause the posted message thus reduced in size to be displayed in each display region.

Note that a posted message may include data other than text data, such as image data and audio data. The message display section 304 can also cause data other than text data (or a link to the data other than text data) to be displayed in a display region.

(Display Change Section)

In a case where an operation is carried out via the touch panel 120 or the operation button 130 when a posted message is being displayed on the display screen, the display change section 308 causes the content displayed on the display screen to be changed in accordance with the content of the operation. A method by which the display change section 308 changes the content displayed includes the following (1) through (4).

(1) In a case where a horizontal flicking operation is carried out with respect to a given one of the plurality of display regions being displayed, the display change section 308, without changing the content displayed in other display regions, changes the posted message to be displayed in the given one of the plurality of display regions, sequentially in accordance with the order of posting.

For example, in a case where a leftward flicking operation is carried out in a given one of the plurality of display regions, the posted message to be displayed in the display region is changed to another posted message whose posting date and time is later than that of the posted message currently displayed.

In an opposite case where a rightward flicking operation is carried out in a given one of the plurality of display regions, the posted message to be displayed in the display region is changed to another posted message whose posting date and time is earlier than that of the posted message currently displayed.

(2) In a case where a vertical flicking operation is carried out with respect to the display screen when a part of a plurality of display regions is being displayed on the display screen (that is, when not all of the display regions can be displayed on the display screen), the display change section 308 causes the positions where the plurality of display regions are displayed to be scrolled in the vertical direction, so that the display region to be displayed on the display screen is sequentially changed.

For example, in a case where an upward flicking operation is carried out, the display change section 308 causes the part of the plurality of display regions to be scrolled upward, so that another display region, whose display order is later than that of the part of the plurality of display regions, is displayed in a space which has become available in a lower part of the display screen.

In an opposite case where a downward flicking operation is carried out, the display change section 308 causes the part of the plurality of display regions to be scrolled downward, so that another display region, whose display order is earlier than that of the part of the plurality of display regions, is displayed in a space which has become available in an upper part of the display screen.

(3) In a case where a predetermined selecting operation is carried out with respect to a given one of a plurality of display regions being displayed on the display screen, a plurality of posted messages of one time series corresponding to the given one of the plurality of display regions are displayed on the display screen so as to be arranged along the vertical direction in order of posting.

(4) In a case where a vertical flicking operation is carried out with respect to the display screen when a part of the plurality of posted messages of the given one of the plurality of time series is being displayed on the display screen (that is, not all of the posted messages can be displayed on the display screen) as a result of (3), the positions where the plurality of posted messages are displayed are scrolled in the vertical direction, so that the posted message to be displayed in the display screen is sequentially changed.

For example, in a case where an upward flicking operation is carried out, the part of the plurality of posted messages is scrolled upward, so that another posted message, whose posting order is later than that of the part of the plurality of posted messages, to be displayed in a space that has become available in a lower part of the display screen.

In an opposite case where a downward flicking operation is carried out, the part of the plurality of posted messages is scrolled downward, so that another posted message, whose posting order is earlier than that of the part of the plurality of posted messages, is displayed in a space that has become available in an upper part of the display screen.

(Procedures of Display Process)

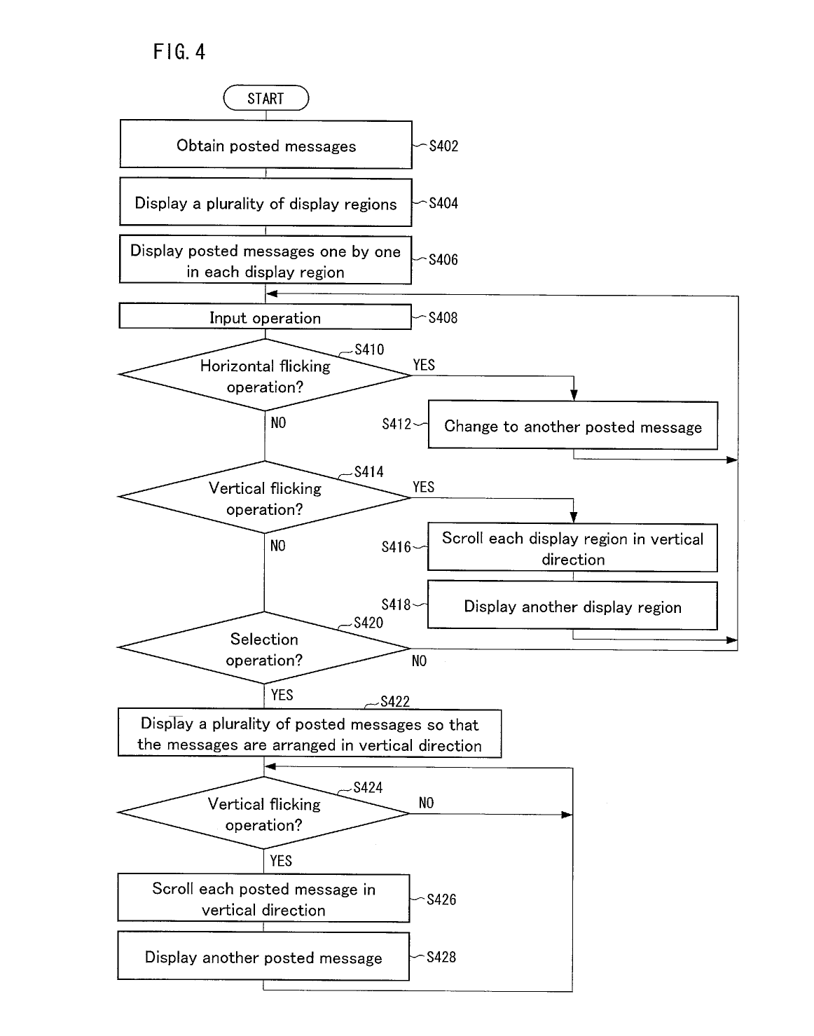

Next, with reference to FIG. 4, the following description will discuss procedures of a display process carried out by the information terminal device 100 in accordance with the embodiment. FIG. 4 is a flowchart showing the procedures of the display process carried out by the information terminal device 100 in accordance with the embodiment.

(Display of Message)

First, the message acquisition section 302 obtains, from a message-posting site, posted messages of each of a plurality of time series (step 402).

Next, the message display section 304 causes a plurality of display regions of the respective plurality of time series to be displayed on the display screen of the display 110 so as to be arranged along the vertical direction (step 404).

Then, the message display section 304 causes posted messages of a time series corresponding to each of the plurality of display regions to be displayed one by one in the each of the plurality of display regions (step 406).

(Change of Message Displayed)

In a case where an operation is subsequently carried out by the touch panel 120 or the operation button 130 (step S408), the display change section 308 causes the content displayed on the display screen to be changed in accordance with the content of the operation (steps S410 through S420).

For example, in a case where a horizontal flicking operation is carried out with respect to a given one of the plurality of display regions being displayed on the display screen (step S410: Yes), the display change section 308 changes the posted message to be displayed in the given one of the plurality of display regions to another posted message (step S412). Then, the information terminal device 100 causes the process to return to step S408.

In a case where a vertical flicking operation is carried out with respect to the plurality of display regions being displayed on the display screen (step S414: Yes), the display change section 308 causes the plurality of display regions to be scrolled in the vertical direction (step S416) and causes another display region to be displayed on the display screen (step S418). Then, the information terminal device 100 causes the process to return to step S408.

In a case where a predetermined selecting operation is carried out with respect to a given one of the plurality of display regions being displayed on the display screen (step S420), the display change section 308 causes a plurality of posted messages of a time series corresponding to the given one of the plurality of display regions to be displayed on the display screen so as to be arranged along the vertical direction in order of posting (step S422).

Then, in a case where a vertical flicking operation is further carried out with respect to the plurality of posted messages displayed on the display screen (step S424: Yes), the display change section 308 causes each of the plurality of posted messages to be scrolled in the vertical direction (step S426), and causes another posted message to be displayed on the display screen (step S428). Subsequently, the information terminal device 100 causes the process to return to step S424.

(Specific Example of Display Process)

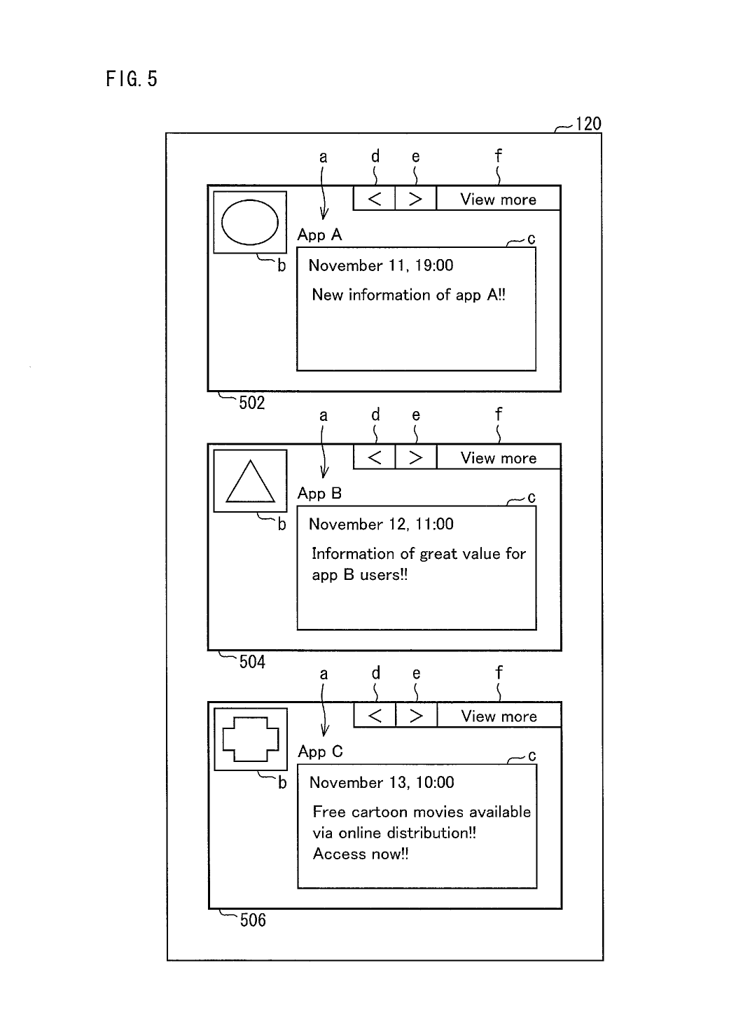

Next, with reference to FIGS. 5 through 10, the following description will discuss a specific example of the display process carried out by the information terminal device 100.

(Initial Display)

FIG. 5 is a view illustrating a specific example of the display process carried out by the information terminal device 100 in accordance with the embodiment, the view illustrating an example of how the message display section 304 causes a plurality of display regions to be displayed.

In the example illustrated in FIG. 5, a display region 502, a display region 504, and a display region 506 are displayed so as to be arranged in the vertical direction on the display screen of the display 110.

The display region 502 is allocated to an application “app A” and is for displaying a time series of an account. The display region 504 is allocated to an application “app B” and is for displaying a time series of an account. The display region 506 is allocated to an application “app C” and is for displaying a time series of an account.

FIG. 5 and subsequent drawings illustrate an example in which a title of an application corresponding to each display region is displayed in the each display region. Note that any information can be displayed in each display region provided that the information is related to a specific account of a specific message-posting service. For example, in place of or in addition to the title of the application, a name of the message-posting service, a name of the account, and a service name that uses the account, a company name that uses the account, etc. can be displayed.

In each display region, the title of a corresponding application (indicated by “a” in FIG. 5), a profile image (indicated by “b” in FIG. 5), and the most recently posted message in the time series of a corresponding account (indicated by “c” in FIG. 5) are displayed. Further, in each display region, a “<” button (indicated by “d” in FIG. 5), a “>” button (indicated by “e” in FIG. 5), and a “view more” button (indicated by “f” in FIG. 5) are displayed.

For example, the display screen described above is displayed when an information distribution service is used, and the accounts described above are collectively obtained from a provider of the information distribution service when the information distribution service is used.

The information distribution service in the present embodiment can be one realized by a dedicated application installed in the information terminal device 100, or one realized by a web page displayed on a web browser.

Although the display regions have an identical size in FIG. 5, the display regions can have respective different sizes. For example, the size of each of the display regions (in particular, the size in the vertical direction) can be automatically adjusted in accordance with the amount of information of a posted message displayed in the each of the display regions.

In this case, the size of each of the display regions can be adjusted so that all of the information included in a posted message is displayed. Further, the size of each of the display regions can be limited so as not to exceed a predetermined threshold value.

Further, the size of each of the display regions can be changed by means of an operation by the user. For example, it is possible to employ a configuration in which the size of a display region is initially made relatively small so that a part of the information of the posted messages (for example, information equivalent of 10 lines) is displayed, and, in a case where the user carries out an operation for enlarging the display region, the size of the display region is enlarged so that all of the information of the posted message is displayed.

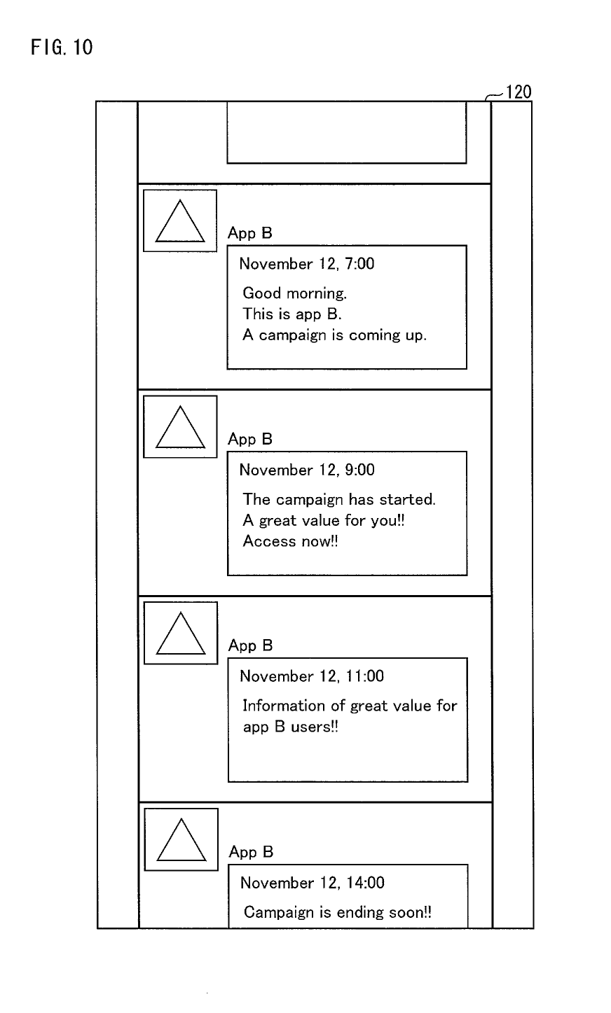

Note that in some cases, a new message is posted with respect to at least one of the plurality of time series thus being displayed, so that the at least one of the plurality of time series is updated. The information terminal device 100 can immediately reflect the update of the at least one of the plurality of time series. Alternatively, instead of immediately reflecting the update, the information terminal device 100 can reflect the update when a predetermined update condition (for example, when a predetermined update button is pressed, when display as illustrated in FIG. 5 is carried out again, when display as illustrated in FIG. 10 is carried out, and the like) is satisfied.

(At the Time of Horizontal Flicking Operation)

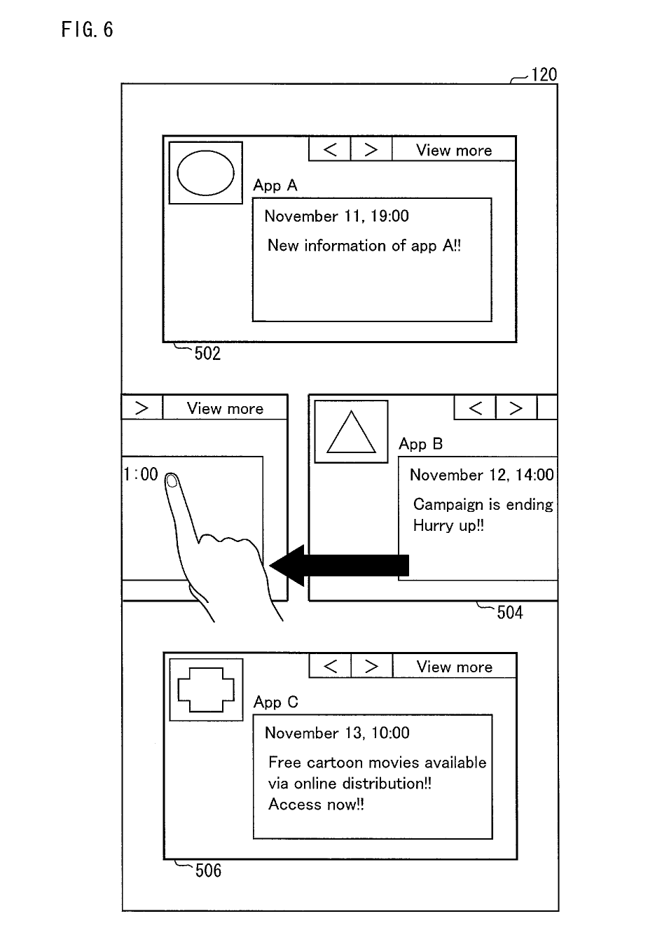

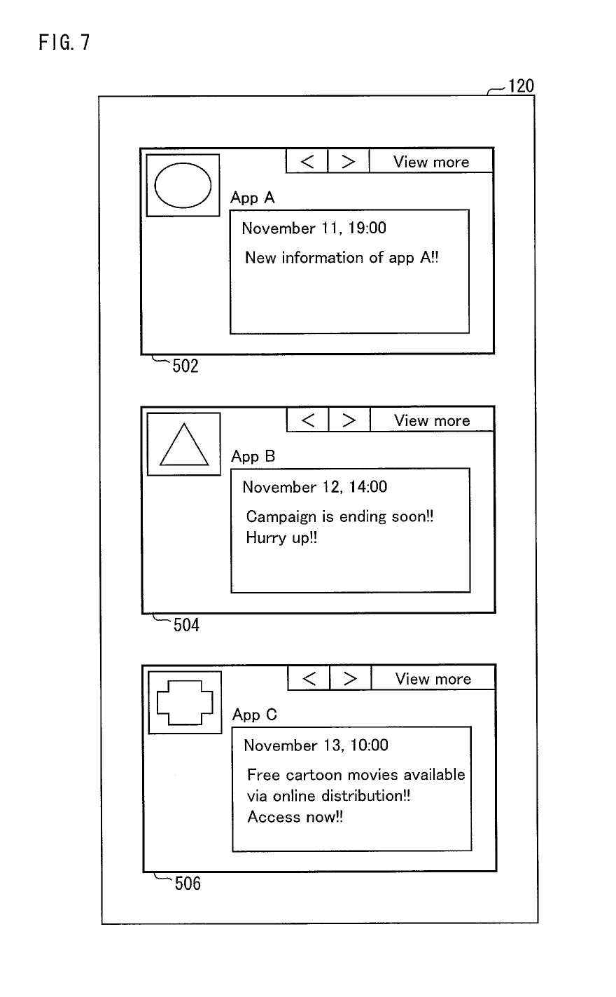

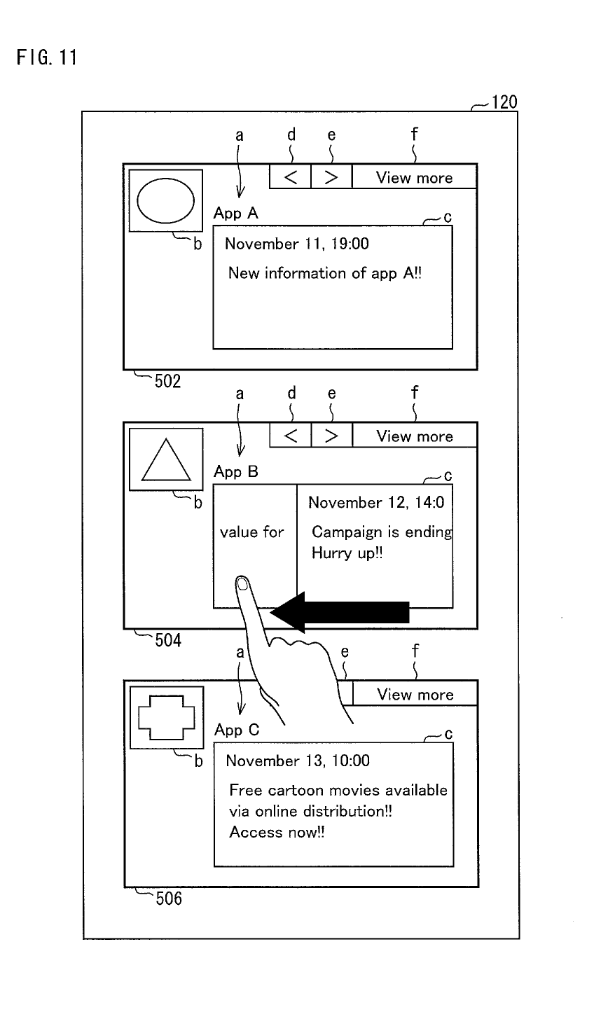

FIGS. 6 and 11 are views each illustrating a specific example of the display process carried out by the information terminal device 100 in accordance with the embodiment, the views each illustrating an example of a horizontal flicking operation. FIG. 7 is a view illustrating a specific example of the display process carried out by the information terminal device 100 in accordance with the embodiment, the view illustrating an example of how the display change section 308 causes the content displayed on the display screen to be changed.

As described above, in a case where a horizontal flicking operation is carried out with respect to a given one of a plurality of display regions being displayed on the display screen, the information terminal device 100 of the present embodiment causes the posted message which is to be displayed in the given one of the plurality of display regions to be changed to another posted message.

For example, as illustrated in FIG. 6, in a case where a leftward flicking operation is carried out with respect to the display region 504 among the display regions 502, 504, and 506 illustrated FIG. 5, the information terminal device 100 changes the posted message to be displayed in the display region 504 from a currently displayed posted message to another posted message whose posting date and time is later than that of the currently displayed posted message.

This causes the new, another posted message to be displayed in the display region 504 as illustrated in FIG. 7. At this time, both of the display regions 502 and 506 remain in a state before the leftward flicking operation was carried out, and there is no change in the posted messages displayed in the respective display regions 502 and 506.

Note that the example illustrated in FIG. 6 is an example in which a horizontal flicking operation with respect to a display region causes a whole of the display region to be scrolled in the horizontal direction, so that the posted message is changed to another one. Alternatively, it is possible to employ a configuration in which, for example, as illustrated in FIG. 11, the horizontal flicking operation causes only the posted message to be changed to another one without causing the whole of the display region to be scrolled in the horizontal direction.

(At the Time of Vertical Flicking Operation)

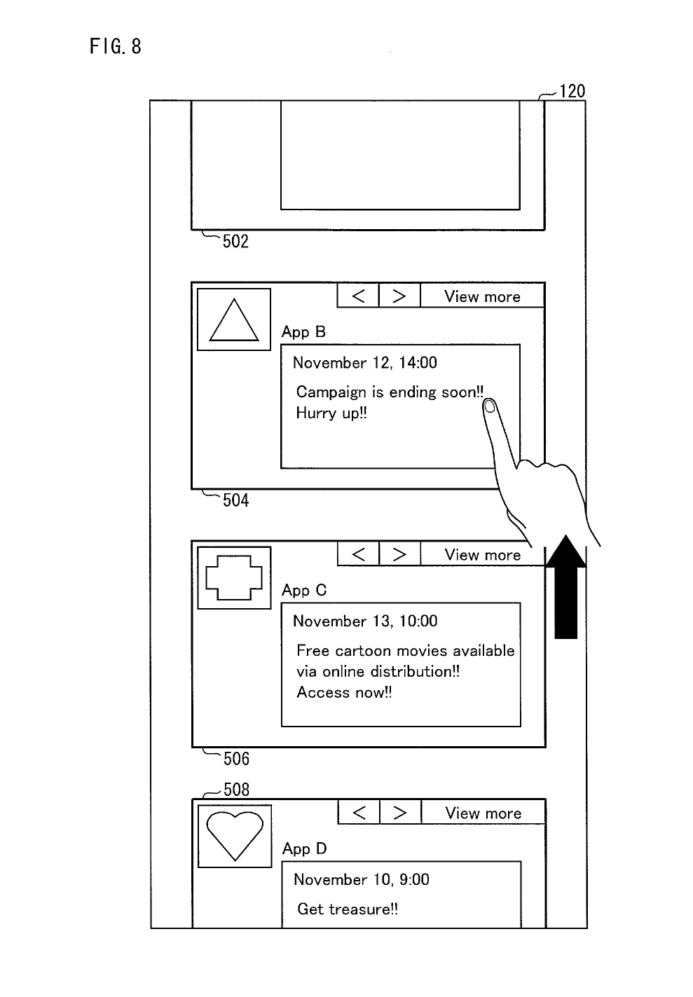

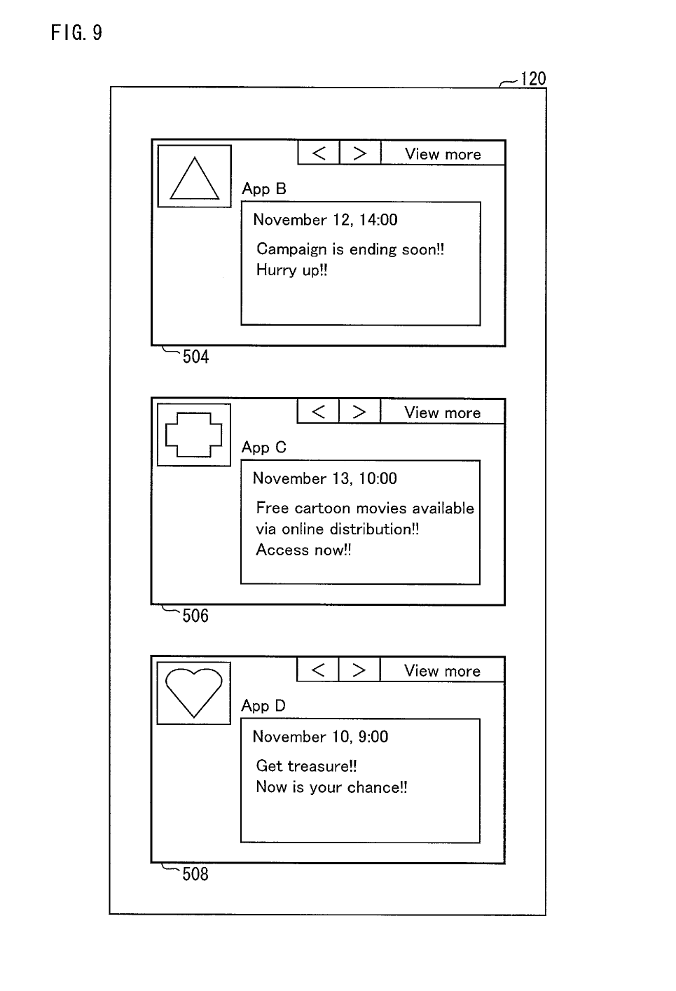

FIG. 8 is a view illustrating a specific example of the display process carried out by the information terminal device 100 in accordance with the embodiment, the view illustrating an example of a vertical flicking operation. FIG. 9 is a view illustrating a specific example of the display process carried out by the information terminal device 100 in accordance with the embodiment, the view illustrating an example of how the display change section 308 causes the content displayed on the display screen to be changed.

As described above, in a case where a vertical flicking operation is carried out with respect to a plurality of display regions being displayed on the display screen, the information terminal device 100 of the present embodiment scrolls each of the display regions in the vertical direction, and displays another display region on the display screen.

For example, as illustrated in FIG. 8, in a case where an upward flicking operation is carried out with respect to the display regions 502, 504, and 506 illustrated in FIG. 7, the information terminal device 100 scrolls the display regions 502, 504, and 506 upward. Consequently, as illustrated in FIG. 8, the display region 502 is scrolled out of the display screen from an upper part of the display screen, and in place of the display region 502, the display region 508 is scrolled into the display screen from a lower part of the display screen. As a result, the display regions 504, 506, and 508 are displayed on the display screen display as illustrated in FIG. 9.

(At the Time of Predetermined Selecting Operation)

FIG. 10 is a view illustrating a specific example of the display process carried out by the information terminal device 100 in accordance with the embodiment, the view illustrating an example of how the display change section 308 causes the content displayed on the display screen to be changed.

As described above, in a case where a predetermined selecting operation is carried out with respect to a given one of a plurality of display regions being displayed on the display screen, the information terminal device 100 of the present embodiment causes a plurality of posted messages of a time series corresponding to the given one of the plurality of display regions to be displayed on the display screen so as to be arranged in order of posting. In the present embodiment, an operation of selecting the “view more” button displayed in each display region is set as the predetermined selecting operation.

Further, in a case where a vertical flicking operation is carried out with respect to the display screen when a plurality of posted messages of a time series are being displayed on the display screen, the information terminal device 100 of the present embodiment scrolls the plurality of posted messages in the vertical direction, so that the posted message to be displayed on the display screen is sequentially changed.

For example, in a case where an operation of selecting the “view more” button is carried out in the display region 504 illustrated in FIG. 9, the information terminal device 100 causes a plurality of posted messages of a time series corresponding to the display region 504 (that is, a time series including only posted messages of the application “app B”) to be displayed on the display screen so as to be arranged along the vertical direction in order of posting, as illustrated in FIG. 10.

Further, in a case where an upward flicking operation is carried out with respect to the display screen of the display 120, the information terminal device 100 scrolls the plurality of posted messages of the application “app B” upward, so that more recently posted messages of the application “app B” are sequentially displayed on the display screen of the display 120.

In an opposite case where a downward flicking operation is carried out with respect the display screen of the display 120, the information terminal device 100 scrolls the plurality of posted messages of the application “app B” downward, so that less recently posted messages of the application “app B” are sequentially displayed on the display screen of the display 120.

In this way, according to the information terminal device 100 of the present embodiment, the user can simultaneously view a plurality of time series by means of a plurality of display regions displayed on the display screen.

In particular, in a case where the user wants to sequentially view posted messages of a given specific account, the user can do so by merely carrying out a simple and reliable operation, i.e., a horizontal flicking operation with respect to a corresponding display region, without moving his/her eyes from the corresponding display region.

Further, even in a case where not all of a plurality of time series fit in the display screen, the user can sequentially view the plurality of time series by a simple and reliable operation, i.e., a vertical flicking operation with respect to the display screen.

In particular, since a flicking operation for sequentially viewing posted messages of a specific account and a flicking operation for sequentially viewing a plurality of time series are carried out in respective different directions, the user can carry out these operations intuitively and reliably.

Further, in a case where the user wants to simultaneously view a plurality of messages of a specific time series, the user can do so by simply carrying out a predetermined selecting operation (operation of selecting the “view more” button) with respect to the display region of the specific time series.

### Modified Example

In the embodiment, the direction along which a plurality of time series displayed are arranged (first direction) coincides with the vertical direction, and the direction in which an operation for changing display of posted messages of a given time series is carried out (second direction) coincides with the horizontal direction.

In the present invention, it is suffice to at least design such that the first direction and the second direction are different from each other (in a preferred example, the first direction and the second direction intersect with each other at right angle). The present invention can be practiced in such a manner that display directions and operation directions including the first direction and the second direction are different from those in the embodiment.

For example, the present invention can be practiced in such a manner that each display direction and each display direction coinciding with the “vertical direction” in the embodiment coincide with the “horizontal direction” instead, and each display direction and each display direction coinciding with the “horizontal direction” in the embodiment coincide with the “vertical direction” instead.

In this case, for example, a plurality of time series are displayed so as to be arranged along the horizontal direction of the display screen. In order to change display of posted messages of a given one of the plurality of time series, a vertical flicking operation is carried out with respect to the display region. In order to change the display region to be displayed on the display screen, a horizontal flicking operation is carried out with respect to the display screen.

(Program and Storage Medium)

Each function of the information terminal device 100 described in the embodiment may be realized by means of hardware by use of logic circuits provided on an integrated circuit (IC chip) or may be realized by means of software by use of a CPU (Central Processing Unit).

For example, the information terminal device 100 includes a CPU for executing commands of a program for implementing each function, and a storage device (recording medium) of any kind such as a ROM in which the program is stored, a RAM on which the program is loaded, a memory in which the program and various data are stored. Each function of the information terminal device 100 can be realized by causing the CPU to read out and execute the program stored in the storage device.

For example, a tape such as a magnetic tape or a cassette tape; a disk including (i) a magnetic disk such as a floppy (Registered Trademark) disk or a hard disk and (ii) an optical disc such as a CD-ROM, an MO, an MD, a DVD, or a CD-R; a card such as an IC card (including a memory card) or an optical card; a semiconductor memory such as a mask ROM, an EPROM, an EEPROM (Registered Trademark), or a flash ROM; a logic circuit such as a PLD (Programmable Logic Device) or an FPGA (Field Programmable Gate Array); or the like can be used as the recording medium.

The program may be delivered to the information terminal device 100 over a communications network. The communications network can be of any type as long as at least the program can be transmitted to the information terminal device 100. The communications network may be, for example, the Internet, an intranet, extranet, LAN, ISDN, VAN, CATV communications network, virtual dedicated network (virtual private network), telephone line network, mobile communications network, or satellite communications network.

A transfer medium for delivering the program to the information terminal device 100 can be of any type. The transfer medium may be, for example, wired line, such as IEEE 1394, USB, electric power line, cable TV line, telephone line, or ADSL (Asymmetric Digital Subscriber Line) line. Alternatively, the transfer medium may be wireless, such as infrared radiation (IrDA, remote control), Bluetooth (Registered Trademark), IEEE 802.11 wireless, HDR (High Data Rate), NFC (Near Field Communication), DLNA, mobile telephone network, satellite line, or terrestrial digital network.

(Additional Matter)

The present invention is not limited to the above-described embodiments but allows various modifications within the scope of the claims. Any embodiment derived from an appropriate combination of the technical means disclosed in the different embodiments will also be included in the technical scope of the present invention.

(Applications of the Present Invention)

The embodiment discussed an example case in which the present invention is applied to an information terminal device. The present invention is applicable to any device that is at least capable of displaying posted messages of a message-posting site. For example, the present invention is applicable to a mobile phone, a smart phone, a PDA, a personal computer, a car navigation system, a television receiver, and the like.

(Flicking Operation)

In the embodiment, a horizontal flicking operation and a vertical flicking operation are employed as an example of a moving operation in the horizontal direction and a moving operation in the vertical direction, respectively. Note that the information terminal device 100 can also be configured such that, also in a case where operations (button operation etc.) equivalent to the horizontal and vertical flicking operations are carried out instead of the horizontal and vertical flicking operations, the information terminal device 100 operates similarly as when the horizontal and vertical flicking operations are carried out.

For example, the information terminal device 100 can be configured such that, in a case where an upward or downward operation (for example, (i) an upward or downward moving operation by means of a mouse, a control wheel, a track ball, or the like, (ii) pressing of an “up” button or a “down” button (including a hardware button and a software button), or (iii) the like) is carried out, the information terminal device 100 operates similarly as when a vertical flicking operation is carried out.

Further, the information terminal device 100 can be configured such that, in a case where, after a given display region has been selected, a rightward or leftward operation (for example, (i) a rightward or leftward moving operation by means of a mouse, a control wheel, a track ball, or the like, (ii) pressing of a “right” button or a “left” button (including a hardware button and a software button), or (iii) the like) is carried out, the information terminal device 100 operates similarly as when a horizontal flicking operation is carried out with respect to the display region.

(Unit of Display of Posted Messages)

In the embodiment, a unit of display of posted messages in a display region and a unit of change of the display of the posted messages in the display region are both one by one, but can also be two by two or larger units.

[Conclusion]

As described above, the display device (information terminal device 100) in accordance with the present embodiment is a display device capable of displaying, on a display screen, a posted message of a message-posting site, including: message display means (message display section 304) which (i) displays a plurality of display regions on the display screen so that the plurality of display regions are arranged along a first direction of the display screen, the plurality of display regions each being for a time series of posted messages, and (ii) displays, in each of the plurality of display regions, a posted message of a time series corresponding to the each of the plurality of display regions; and display change means (display change section 308) which, in a case where a moving operation in a second direction, which is different from the first direction, is carried out with respect to a given one of the plurality of display regions, sequentially changes a posted message to be displayed in the given one of the plurality of display regions.

According to the display device, the user can view a plurality of time series on the same display screen. In particular, the provision of the plurality of display regions for the respective time series allows clearly recognizing that the time series are distinguished from one another. When the user sequentially views posted messages of a specific account, the user can do so without moving his/her eyes from a corresponding display region.

Further, according to the display device, the sequential viewing of posted messages of a specific account is realized by a simple and reliable operation, i.e., a moving operation in the second direction with respect to a corresponding display region. In particular, since (i) the moving operation is carried out in the second direction (e.g., the horizontal direction) different from the first direction (e.g., the vertical direction) along which the plurality of display regions are arranged and (ii) the moving operation does not affect content displayed in other display regions, the moving operation is more reliable despite being an intuitive operation.

Furthermore, according to the display device, since a moving operation in the second direction with respect to a display region does not affect other display regions, it is also possible to display a given posted message in a display region while displaying a posted message in another display region, so that these messages can be compared with each other.

The display device preferably has a configuration in which the message display means displays, one by one in each of the plurality of display regions, a posted message of a time series corresponding to the each of the plurality of display regions; and in a case where a moving operation in the second direction is carried out with respect to a given one of the plurality of display regions, the display change means sequentially changes, one by one, a posted message to be displayed in the given one of the plurality of display regions.

According to the configuration, posted messages are displayed one by one in each of the plurality of display regions, so that the size of the each of the plurality of display regions can be minimized, and more display regions can be displayed on the display screen, accordingly. In particular, in a case where a plurality of messages are displayed in a single display region so as to be arranged along the first direction, the user tends to erroneously carry out a moving operation in the first direction (e.g., such cases where even though a message cannot be changed to another message by a moving operation in the first direction, the user carries out a moving operation in the first direction with an intention to change a message to another message), whereas according to the display device, posted messages are displayed one by one in a single display region, so that the user is not likely to erroneously carry out a moving operation in the first direction.

The display device preferably has a configuration in which, in a case where a moving operation in the first direction is carried out with respect to the display screen when the plurality of display regions are being displayed on the display screen, the display change means moves display positions of the respective plurality of display regions in the first direction, thereby sequentially changing a display region to be displayed on the display screen.

According to the configuration, an operation for sequentially viewing posted messages of a specific account and an operation for sequentially viewing the plurality of time series are carried out in respective different directions. This allows the user to operate these operations intuitively and reliably.

In particular, since an operation in the first direction does not affect content displayed in each of the plurality of display regions, it is possible to sequentially view the plurality of time series while a posted message displayed in the each of the plurality of display regions is fixed.

Further, the user can carry out an operation in the second direction with respect to each of the plurality of display regions so as to cause a given posted message to be displayed in the each of the display region, and then, in this state, carry out an operation in the first direction, thereby comparing given posted messages of the respective plurality of time series with one another.

The display device preferably has a configuration in which, in a case where a predetermined selecting operation is carried out with respect to a given one of the plurality of display regions, the display change means displays, on the display screen, a plurality of posted messages of a time series corresponding to the given one of the plurality of display regions so that the plurality of posted messages are arranged along the first direction of the display screen.

According to the configuration, the user can not only view a plurality of time series simultaneously, but also easily view more information of a given time series by carrying out the predetermined selecting operation.

The display device preferably has a configuration in which, in a case where a moving operation in the first direction is carried out with respect to the display screen when the plurality of posted messages of the given one of the plurality of time series are being displayed on the display screen, the display change means moves display positions of the respective plurality of posted messages in the first direction, thereby sequentially changing a posted message to be displayed on the display screen.

According to the configuration, a direction along which a plurality of posted messages are arranged, a direction in which the plurality of posted messages are moved, and a direction in which a moving operation for causing the movement is carried out are identical. This allows the user to view a plurality of posted messages easily by an intuitive and reliable operation.

Further, an information terminal device in accordance with the present embodiment includes the display device.

According to the information terminal device, it is possible to provide an information terminal device that brings about similar advantageous effects as those provided by the display device.

Further, the display method in accordance with the present embodiment is a display method for displaying, on a display screen, a posted message of a message-posting site, comprising the steps of: (i) displaying a plurality of display regions on the display screen so that the plurality of display regions are arranged along a first direction of the display screen, the plurality of display regions each being for a time series of posted messages, and (ii) displaying, in each of the plurality of display regions, a posted message of a time series corresponding to the each of the plurality of display regions; and in a case where a moving operation in a second direction, which is different from the first direction, is carried out with respect to a given one of the plurality of display regions, sequentially changing a posted message to be displayed in the given one of the plurality of display regions.

According to the display method, it is possible to provide a display device with which, by causing the display device to carry out the display method, similar advantageous effects as those achieved by the display device are provided.

Further, the program in accordance with the present embodiment is a program for causing a computer to function as the display device, the program being configured to cause the computer to function as each of the means of the display device.

According to the program, it is possible to provide a computer with which, by causing the computer to execute the program, similar advantageous effects as those achieved by the display device are provided.

Further, the recording medium in accordance with the present embodiment is a computer-readable recording medium in which the program recited is stored.

According to the recording medium, it is possible to provide, to a program via the recording medium, the program capable of providing similar advantageous effects as those achieved by the display device.

### INDUSTRIAL APPLICABILITY

The present invention is applicable to a various display device, such as an information terminal device, a mobile phone, a smart phone, a PDA, a personal computer, which is capable of displaying a posted message of message-posting site.

### REFERENCE SIGNS LIST

100 INFORMATION TERMINAL DEVICE (DISPLAY DEVICE)
102 PROCESSING CIRCUIT
104 STORAGE DEVICE
108 DISPLAY DRIVING CIRCUIT
110 DISPLAY
120 TOUCH PANEL
130 OPERATION BUTTON
140 WIRELESS COMMUNICATIONS MODULE
302 MESSAGE ACQUISITION SECTION
304 MESSAGE DISPLAY SECTION (MESSAGE DISPLAY MEANS)
308 DISPLAY CHANGE SECTION (DISPLAY CHANGE MEANS)

1. A display device capable of displaying, on a display screen, a posted message of each of a plurality of accounts respectively corresponding to a plurality of message-posting sites, comprising:
message display means which (i) displays a plurality of display regions on the display screen so that the plurality of display regions are arranged along a first direction of the display screen so as to be distinguishable from each other, the plurality of display regions each being for displaying a posted message of a corresponding one of the plurality of accounts, and (ii) displays, in each of the plurality of display regions, a posted message of a time series of an account corresponding to the each of the plurality of display regions; and
display change means which, in a case where a moving operation in a second direction, which is different from the first direction, is carried out with respect to a display region corresponding to a given one of the plurality of accounts among the plurality of display regions, sequentially changes a posted message of the given one of the plurality of accounts to be displayed in the display region.

2. The display device as set forth in claim 1, wherein:
the message display means displays, one by one in each of the plurality of display regions, a posted message of a time series of an account corresponding to the each of the plurality of display regions; and
in a case where a moving operation in the second direction is carried out with respect to a display region corresponding to a given one of the plurality of accounts among the plurality of display regions, the display change means sequentially changes, one by one, a posted message of the given one of the plurality of accounts to be displayed in the display region.

3. The display device as set forth in claim 1, wherein:
in a case where a moving operation in the first direction is carried out with respect to the display screen when the plurality of display regions are being displayed on the display screen, the display change means moves display positions of the respective plurality of display regions in the first direction, thereby sequentially changing a display region to be displayed on the display screen.

4. A display device as set forth in claim 1, wherein:
in a case where a predetermined selecting operation is carried out with respect to a display region corresponding to a given one of the plurality of accounts among the plurality of display regions, the display change means displays, on the display screen, a plurality of posted messages of a time series of the given one of the plurality of accounts so that the plurality of posted messages are arranged along the first direction of the display screen.

5. The display device as set forth in claim 4, wherein:
in a case where a moving operation in the first direction is carried out with respect to the display screen when the plurality of posted messages of the time series of the given one of the plurality of accounts are being displayed on the display screen, the display change means moves display positions of the respective plurality of posted messages in the first direction, thereby sequentially changing a posted message to be displayed on the display screen.

6. An information terminal device comprising a display device recited in claim 1.

7. A display method for displaying, on a display screen, a posted message of each of a plurality of accounts respectively corresponding to a plurality of message-posting sites, comprising the steps of:
(i) displaying a plurality of display regions on the display screen so that the plurality of display regions are arranged along a first direction of the display screen so as to be distinguishable from each other, the plurality of display regions each being for displaying a posted message of a corresponding one of the plurality of accounts, and (ii) displaying, in each of the plurality of display regions, a posted message of a time series of an account corresponding to the each of the plurality of display regions; and
in a case where a moving operation in a second direction, which is different from the first direction, is carried out with respect to a display region corresponding to a given one of the plurality of accounts among the plurality of display regions, sequentially changing a posted message of the given one of the plurality of accounts to be displayed in the display region.

8. A non-transitory computer-readable recording medium in which a program configured to cause a computer to function as each of the means of a display device recited in claim 1 is stored.

9. (canceled)
